(19) United States
(12) Patent Application Publication
(10) Pub. No.: US 2005/0128053 A1
(43) Pub. Date: Jun. 16, 2005

(54) Portable modular wirefree identification signal transmitter and wirefree access control system

(76) Inventors: Wolfgang M. Bareither, Bruehl (DE); Thomas Kaiser, Solingen (DE); Guido Pfehr, Bornheim (DE)

Correspondence Address: Henneman & Saunders, 714 W. Michigan Ave., Three Rivers, MI, 49093, US

(21) Appl. No.: 10/964,573

(22) Filed: Oct. 13, 2004

(30) Foreign Application Priority Data
Apr. 9, 2003 (WO) PCT/EP03/03659
Apr. 17, 2002 (DE) 102 17 533.0-53

(51) Int. Cl. G06F 7/04

(52) U.S. Cl. 340/5.64; 340/5.61

(57) ABSTRACT

The invention proposes a portable modular wirefree identification signal transmitter for actuating, in particular for opening and/or closing, access points such as doors, gates, etc., remotely, having a housing which has at least one externally accessible receptacle for accommodating a respective exchangeable system module, an identification code of a wirefree access control system being stored in the system module. A control device is arranged in the housing and is configured to read the identification code of a system module which is accommodated. At least one transmitter device is permanently arranged in the housing and is adapted to transmit the identification code of a system module which is accommodated, to a reader device assigned to an access point. Depending on the system module accommodated, the identification signal transmitter can be used for opening and closing access points with different wirefree access control technologies.

### TECHNICAL FIELD

The present invention relates to a portable modular wirefree (wireless) identification signal transmitter for actuating, in particular for opening and/or closing, access points such as doors, gates etc. remotely.

The invention also relates to a wirefree access control system for at least one access point such as a door or a gate, the access control system having a lock for the access point and a reader device which is assigned to the access point, and when a valid identification code is received it actuates the lock in order to open the access point, and the access control system having a portable modular wirefree identification signal transmitter.

### BACKGROUND OF THE INVENTION

Such identification signal transmitters are generally known as elements of access control systems and installations. An access control system is understood in the present context as a system which controls an individual access point. An access control installation is understood in the present context as a plurality of such access control systems which are based on the same technology. This will also be explained below.

Such access control systems and installations are used, for example, in relatively large office and company complexes. They permit persons located in the complex to have access exclusively to such spatial areas for which they are authorized.

According to the classic approach, what are referred to as lock systems are used for this purpose. In such systems, mechanical locks based on the same lock technology are used, for example, within an office complex. The locks are coded so that a mechanical key generally provides exclusive access to a specific office area. In addition, all keys generally provide access to common areas within the office complex. This simple differentiation facility can be qualified as desired. For example it is possible for all the employees of a company to have access to the company rooms within an office complex. However, only the accountant and the owner of the company have a key which additionally allows access to the accounts room.

Such access control systems and installations have also been available on a contactless basis for a number of years. For example, a batteryless passive transponder as a key tag or attachment with the designation “Clip Tac” is known from the present applicant. In addition, passive transponders are also known in the form of ISO transponder cards in the cheque card format.

The two lock media are passive transponders. They have an antenna coil and a chip which is coupled to the antenna coil. A voltage can be induced in the antenna coil by means of a read signal. The voltage is used by the chip to read out an identification code stored on it and to modulate it onto a signal. The modulated signal is then emitted by means of the induced energy and read by a reader device.

Such passive transponders can be read over distances from several centimetres up to approximately 20 to 30 cm.

Access control systems and installations based on transponders are commercially available based on different technologies. Depending on the technology, identification codes with a different bit number, different transmission and reception frequencies, different transmission and reception protocols, etc., are used. These different “technologies” are not compatible with one another. This means that the transponders of one technology cannot be read by reader devices of another technology, and vice versa.

There is an increasing tendency towards contactless or wirefree access control technologies not only in the field of building technology. For example, in the motor vehicle sector there are access control systems based on infrared and radio. In these systems, an identification signal transmitter which is carried by a driver of a motor vehicle is generally embodied as an active transmitter. The identification signal transmitter consequently generally has an electrical battery for supplying power, a chip which is fed from the battery, and an antenna. In many systems the driver of the motor vehicle has to press a knob on the identification signal transmitter in order to initiate a process in which the identification code which is stored on the chip is transmitted. If his motor vehicle is located in the transmission range of the identification signal transmitter, the identification code is received by the vehicle, checked for correctness and the access to the motor vehicle is then allowed. This is generally carried out by unlocking the central locking system.

These access control systems are frequently combined with an immobilizer. In this case, a passive transponder is also frequently arranged in the identification signal transmitter. The passive transponder is then read by a reader device in the motor vehicle, which can be arranged, for example, in the region of the ignition lock. The ignition and other electrical systems of the motor vehicle remain locked—even if, for example, the central locking system is opened—until a valid transponder is read.

In other access control systems for motor vehicles, the identification signal transmitter is embodied as an active transponder, but is normally in a sleep mode. A wakeup signal is then transmitted by the motor vehicle at regular intervals. As soon as the driver of the motor vehicle with the identification signal transmitter is located in the transmission range of the motor vehicle, the identification signal transmitter is “woken up” and, for its part, transmits its identification code to the motor vehicle. The central locking system in the motor vehicle is then unlocked.

Of course, wirefree access control systems can also be combined with the immobilizer. The immobilizer is also automatically unlocked when the central locking system is unlocked.

The access control systems with active identification signal transmitters are not compatible with one another. The technologies used differ from one manufacturer of vehicles to another.

The access control systems with active identification signal transmitters are not compatible with access control systems which use passive identification signal transmitters.

This all leads to a situation in which a person frequently carries a plurality of such identification signal transmitters on his person, for example one for his office, one for his company vehicle, a further one for his private car. Since the identification signal transmitters are generally larger than conventional mechanical keys, such a “bunch” of identification signal transmitters quickly becomes cumbersome.

It would therefore be ideal if the technologies of the different access control systems and installations were to be harmonized with one another. Then, for example a specific identification code would be assigned to a person and would then be applied to the various technologies so that the person has to carry only a single identification signal transmitter on his person. However, efforts in this direction have still not led to any convincing success.

Against this background, the object of the present invention is to specify an improved portable modular wirefree identification signal transmitter and an improved wirefree access control system for at least one access point.

### SUMMARY OF THE INVENTION

The above object is achieved by means of a portable modular wirefree identification signal transmitter for actuating, in particular for opening and/or closing, access points such as doors, gates, etc., remotely, the identification signal transmitter having:
a housing which has at least one receptacle for accommodating a respective exchangeable system module, an identification code of a wirefree access control system being stored in the system module,
a control device which is permanently arranged in the housing and is configured to read the identification code of a system module which is being accommodated, and
at least one transmitter device which is permanently arranged in the housing and, in conjunction with the control device, has the purpose of transmitting the identification code of a system module which is being accommodated to a reader device of the access control system, which reader device is assigned to an access point,
wherein the identification signal transmitter can be used for opening and closing access points with different wirefree access control technologies.

The above object is also achieved by means of a wirefree access control system for at least one access point such as a door or a gate, wherein the access control system has a lock for the access point and a reader device which is assigned to the access point, and when a valid identification code is received, it actuates the lock in order to open the access point, and wherein the access control system has at least one portable modular identification signal transmitter of the type designated above.

The present invention makes it possible to use a single physical identification signal transmitter for different access control technologies.

In other words, a system module which is based on a specific access control technology can be inserted into one and the same physical identification signal transmitter. Alternatively, another system module which is based on a further access control technology can be inserted.

The identification signal transmitter is consequently of modular design. The components which are permanently installed in the identification signal transmitter, such as the control device and transmitter device, are configured for use for different access control technologies.

Accordingly, depending on the system module used, the identification signal transmitter can be used to actuate access points of different access control installations.

The object is achieved completely in this way.

It is particularly preferred if the identification signal transmitter also has a receiver device for receiving signals from the reader device.

In this case, the identification signal transmitter is suitable for setting up bidirectional communication with the reader device, as a result of which the security can be increased.

It is particularly preferred if an antenna which forms the transmitter device and/or the receiver device is permanently arranged in the housing.

In the simplest case the antenna may be a coil and be used as a transmitter and receiver coil.

It is particularly preferred if the housing has a plurality of receptacles for accommodating one different system module each.

In this embodiment, in each case a separate receptacle is provided for the system modules with different technologies. This is advantageous in so far as the respective receptacles can be matched precisely to the respective different system modules.

In this embodiment, the identification signal transmitter is of particularly variable construction and makes it possible in particular to accommodate at the same time different system modules with different access control technologies.

This makes it possible for example for one and the same physical identification signal transmitter to be suitable, on the one hand, for unlocking a motor vehicle and, on the other hand, for obtaining access to buildings. In other words, the identification signal transmitter serves as a wirefree “key” both for the motor vehicle of the owner and for his office rooms. This example can be expanded as desired. For example, when suitable system modules are accommodated, the same identification signal transmitter can be used for unlocking and locking a second vehicle and/or the entry door of the private residence of the owner.

In this way it is possible that, despite the presence of different access control technologies for the various access areas, a person will have to carry only a single physical identification signal transmitter on his person.

Alternatively it is possible for a receptacle to be suitable for accommodating different system modules.

According to one preferred embodiment, at least one system module has an integrated control and transmitter device and does not have any connection to the central control device or transmitter device.

In this embodiment, the modular identification signal transmitter accordingly provides the possibility of also accommodating system modules which are not compatible with the internal control and/or transmitter device. As a result, the variability of the identification signal transmitter is increased further.

It is particularly preferred if an identification code of an access control system is also stored in a system module which is permanently arranged in the housing.

In this embodiment, the identification signal transmitter is, for this reason, permanently assigned to one access control system and can be expanded in a modular fashion by accommodating system modules of other access control systems. For example, the identification code which is stored in the memory which is permanently arranged in the housing may be the identification code of an access control system of a building or of a motor vehicle. By inserting system modules, for example for a further vehicle and/or a system module for a further access control system, it is possible to expand this one identification signal transmitter in a modular fashion in this way.

According to a further preferred embodiment, the housing has a receptacle for an energy store, for example battery or accumulator.

This measure makes it possible to use the identification signal transmitter also for access control technologies which use active identification signal transmitters.

It is particularly preferred here if an interface for charging a rechargeable accumulator which is inserted into the receptacle is provided on the housing.

As a result, frequent battery changes are avoided. The identification signal transmitter may be inserted into a suitable charging unit, for example in the private residence of the owner. Alternatively it is also possible for the charging process to be carried out via the battery of the motor vehicle if, for example, the identification signal transmitter is connected to a charging point in the motor vehicle. If the identification signal transmitter also has a mechanical key (see below), the key which is formed from metal can form the charging interface.

According to a particularly preferred embodiment, an interface for connecting to a programming medium (for example computer) is provided on the housing.

This permits the control device of the identification signal transmitter and/or of system modules which are accommodated to be programmed. For example it is conceivable to change the identification code in a convenient way by means of this connection.

In addition it is preferred if the control device has program-controlled locking means by means of which individual system modules can be locked so that their stored identification code is not transmitted.

This measure has the advantage that the identification signal transmitter can be locked with respect to the system modules which are accommodated, without having to remove the system modules physically. This may be advantageous, for example, if the identification signal transmitter is handed over by its owner to third parties, for example to a motor vehicle workshop. In this case, the owner can lock the identification signal transmitter with respect to, for example, a system module for his private residence so that unauthorized access is prevented from the outset.

Of course, the setting of the program-controlled locking means in this regard can be performed, in particular, by a computer which can be connected to the control device via a suitable interface on the housing.

In a further embodiment, a receptacle for an enabling module is provided on the housing and at least one system module is locked so that its stored identification code is not transmitted if the enabling module is not accommodated.

In this embodiment, which may be provided alternatively or in addition to the program-controlled locking means, it is possible, by simply inserting and removing an enabling module, to lock the identification signal transmitter for specific access control systems.

In particular if the identification signal transmitter is preprogrammed, in the sense that an identification code is stored in a read only memory of the housing, the enabling module can be used to lock or unlock all the additionally accommodated system modules.

According to a further preferred embodiment, at least one activation element which is connected to the control device, is provided on the outside of the housing and, wherein the control device reads the identification code of at least one system module when the activation element is activated, and said control device actuates the transmitter device in order to transmit the identification code.

In this embodiment, the transmission of the identification code is initiated by active intervention of the owner. It is possible here for the activation of the activation element to lead to a situation in which all the identification codes which are located in the identification signal transmitter are transmitted. This may be carried out, for example, in a serial succession. Alternatively, in each case a separate activation element may be provided for this purpose for one or more of the identification codes.

According to a further preferred embodiment, the control device interrogates periodically whether the receiver device has received an activation signal, and when an activation signal is received it reads the identification code of at least one system module and actuates the transmitter device in order to transmit the identification code.

In this embodiment, the control device is in a “sleep mode” in the state of rest and is “woken up” by the reception of an activation signal. The control device then transmits an identification code. The activation signal is generally transmitted here by a reader device to the access point to be actuated.

Which contained identification code is to be transmitted is advantageously detected by the control device as a function of the received activation signal. Accordingly, the control device then merely actuates the “addressed” system module in order to transmit the identification code. Of course, it is also possible for the activation signal to trigger the transmission of an identification code from a memory which is permanently contained in the housing.

It is also advantageous if at least one mechanical key is mounted on the housing so as to be moveable, in particular pivotable, between a protruding locking position and a position of rest which is adjacent the housing.

This measure also expands the modularity of the identification signal transmitter by virtue of the fact that the identification signal transmitter can be used as a “conventional” key.

Of course, the features mentioned above and the features which are to be explained below can be used not only in the respectively specified combination but also in other combinations or in isolation without departing from the scope of the present invention.

### BRIEF DESCRIPTION OF THE DRAWINGS

Exemplary embodiments of the invention are illustrated in the drawing and will be explained in more detail in the following description. In the figures:

FIG. 1 is a schematic illustration of an access control device having a modular wirefree identification signal transmitter according to the invention; and

FIG. 2 is a schematic perspective view of a further embodiment of an identification signal transmitter according to the invention.

### DESCRIPTION OF THE PREFERRED EMBODIMENTS

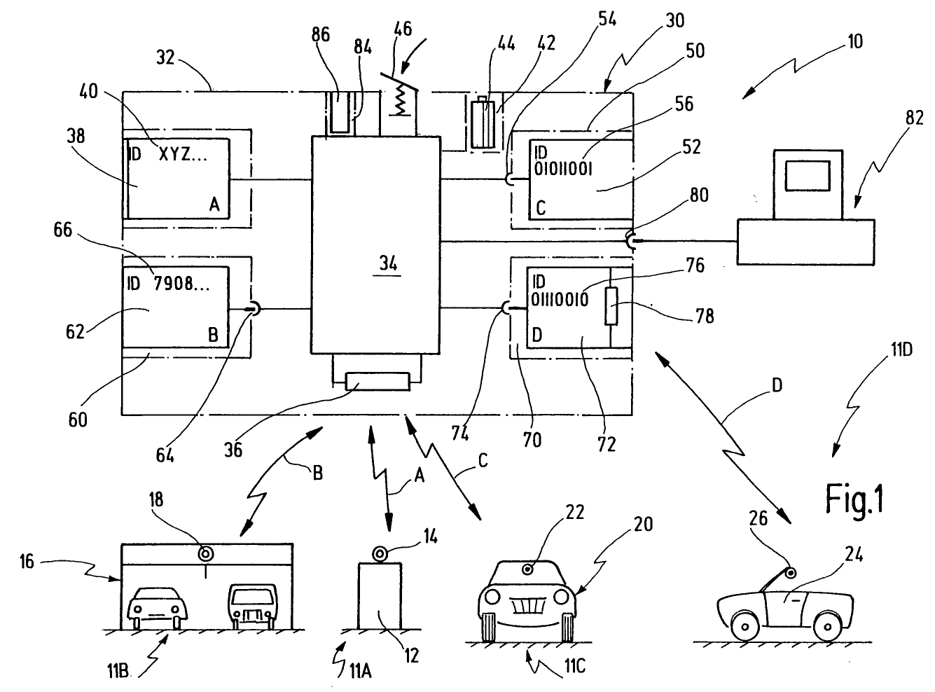

An access control device is designated generally by 10 in FIG. 1.

The access control device 10 is formed by a plurality of access control installations A, B, C and D.

Each access control installation A, B, C and D is based on a separate technology for wirefree access control, and generally contains in each case a plurality of access control systems 11.

The access control installation A has, for example, an access control system 11A for a door 12 of an office. A reader device 14 of the access control system 11A is assigned to the door 12.

The access control installation B has an access control system 11B for a private garage 16 to which a reader device 18 is assigned.

The access control installation C has an access control system 11C for a vehicle 20 to which a reader device 22 is assigned.

The access control installation D has an access control system 11D for a leisure device 24, for example a second vehicle 24, to which a reader device 26 is assigned. The leisure device 24 may also be, for example, an access point to a sports installation, to a locker at a golf club or the like. For the sake of simplicity, reference is made below only to a second vehicle.

The access control installations A, B, C and D can each be based on a different identification technology. For example, the access control installation A is adapted especially for office buildings.

The access control installation B is adapted especially for private residences, in particular for garage doors. The access control installations C and D are adapted especially for motor vehicles. Nevertheless, for example the access control installations C and D may differ in terms of their identification technology, in particular if the motor vehicle 20 and the second vehicle 24 originate from different manufacturers.

All the access control installations A, B, C and D are wirefree access control installations which are either based on active or on passive transponder technology and can be activated by means of portable identification signal transmitters. The identification signal transmitters each have, in a manner known per se, an active or a passive transmitter/receiver or transponder. Each transponder is programmed with a uniquely defined identification code which is assigned to the respective identification signal transmitter, and has at least one transmitter device for transmitting the identification code.

Each access control installation A, B, C, D has in each case a separate identification signal transmitter type so that the identification signal transmitters of a respective access control installation A, B, C, D generally differ only in the identification code. Depending on the programming, it is therefore possible to program one and the same physical identification signal transmitter within an access control installation A, B, C and D for different access control systems 11. However, the identification signal transmitters are not compatible between the various access control installations A, B, C, D. This means that identification signal transmitters of the access control installation A cannot generally be used for access control systems of another access control installation irrespective of their programming.

The technologies of the respective access control installations A, B, C, D can differ both in terms of the bit length of the respective identification code, with respect to the transmission and reception frequency and in particular with respect to the transmission and reception protocols. This means that a person generally must carry a plurality of such identification signal transmitters on his person in order to access his office 12, his private residence (garage 16) and his motor vehicles 20 and 24.

The access control device 10 also has a portable modular wirefree identification signal transmitter 30 which can be used as a universal identification signal transmitter for all four access control installations A, B, C and D. Consequently, the identification signal transmitter 30 which connects these “worlds” to one another results in the superordinate access control device 10.

The identification signal transmitter 30 has a schematically indicated housing 32 in which a control device 34 is permanently arranged. One or more antennas 36, which are embodied as a transceiver device, are also permanently arranged in the housing 32.

A system module 38 for the access control system 11A, that is to say for the office 12, is also permanently arranged in the housing 32.

The system module 38 has an identification code 40 which is composed, for example, of a plurality of bits (generally forty or even more bits).

The identification code 40 is assigned to the office 12. As soon as the reader device 14 receives the identification code 40, the access to the office 12 is made possible for the owner of the identification signal transmitter 30.

The term access is to be understood in this context in a wide sense. It may mean, for example, that doors are either unlocked or opened.

The system module 38 is shown in the illustration in FIG. 1 as a separate module but it can also be integrated into the control device 34.

In addition, an accumulator receptacle 42 for accommodating an energy store in the form of an accumulator 44, which supplies the control device 34 with energy, is also provided on the housing 32.

In addition, a plurality of receptacles, in the present case three, are provided for further system modules on the housing 32 of the identification signal transmitter 30.

For example, the system 32 has a receptacle 50 for a system module 52 for the access control system 11C (i.e. the passenger car 20). As soon as the system module 52 is introduced into the receptacle 50, it is connected to the control device 34 by means of a plug-type connection 54. The control device 34 is configured to read out an identification code 56 which is stored in the system module 52 and to transmit it via the antenna 36.

Consequently, the identification signal transmitter 30 is also configured to permit operation of the motor vehicle 20.

Equally, a pushbutton key 46 is embodied on the housing 32 so as to be accessible from the outside and by means of which an identification process can be initiated. When the pushbutton key 46 is depressed, the control device 34 reads the identification code 56 out of the system module 38 and transmits it via the antenna 36. If the motor vehicle 20 is located in the transmission range of the antenna 36, the reader device 22 reads the transmitted identification code 56 and permits the bearer of the identification signal transmitter 30 to access the motor vehicle 20 on the basis of the valid identification code 56.

In a further receptacle 60, a system module 62 for the access control system 11B is accommodated and it is connected to the control device 34 by means of a plug-type connection 64. Consequently, the control device 34 can also read out an identification code 66 stored in the system module 62 and use it to actuate the access control system 11B.

Finally, the housing 32 has a receptacle 70 for a system module 72 which can be connected to the control device 34 via a plug-type connection 74.

An identification code 76 for the access control system 11D is stored in the system module 72. The system module 72 also has an antenna 78 via which the identification code 76 is transmitted, under the control of the control device 34.

The provision of a “separate” antenna in a system module is appropriate in particular if the access control installation (here D) operates at frequencies for which the antenna 36 is not configured.

In particular if the access control installation is an installation which operates by means of passive transponders, it is even possible to configure a system module in such a way that it does not have any connection to the control device 34 at all.

In addition, the housing 32 has an interface 80 for connection, for example, of a computer 82 (or of another programming medium).

By means of the computer 82 it is possible, for example, to lock or unlock the control device 34 in terms of a program. This means that when the control device 34 is locked, the identification signal transmitter 30 does not transmit any identification codes any longer. This function may be used, for example, if the identification signal transmitter is generally to be deactivated for a specific time. Alternatively, it is also possible to program the control device 34 by means of the computer 82 in such a way that individual system modules (for example C or D) are locked. This makes it possible to hand over the identification signal transmitter 30 in its entirety at a workshop for the vehicle 20 or 24 without the risk of the identification signal transmitter 30 being misused for other purposes.

Of course, the control device 34 can also be unlocked again by means of the computer 82.

In addition it is, if appropriate, possible to use the computer 82 to reprogram the permanently contained system module A and/or reprogram one or more of the system modules B, C and D which are accommodated.

The housing 32 of the identification signal transmitter 30 also has an enabling module receptacle 84 for accommodating an enabling module 86.

If the enabling module 86 is accommodated in the receptacle 84 and accordingly connected to the control device 34, the control device 34 is enabled and can transmit all the identification codes. If the enabling module 86 is removed, the transmitter device 34 is locked.

The enabling module 86 is consequently a hardware lock which can be set up alternatively or in addition to the software lock according to computer 82.

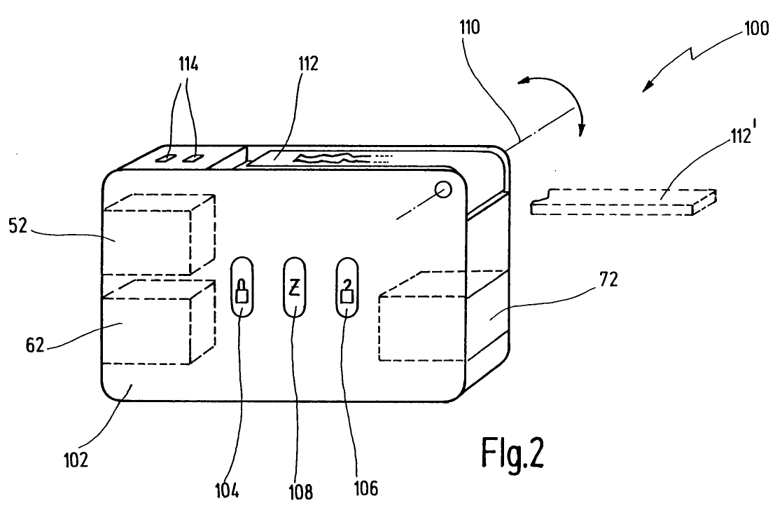

FIG. 2 shows a further embodiment of an identification signal transmitter 100.

The identification signal transmitter 100 is based on the same principles as the identification signal transmitter 30 of the access control device 10 in FIG. 1.

Consequently, the statements above relating to the identification signal transmitter 30 apply equally to the identification signal transmitter 100 unless expressly stated otherwise.

The system module 52 for the access control system 11C is permanently arranged in the identification signal transmitter 100, and the system modules for the access control systems A, B and D are of modular design.

The identification signal transmitter 100 has an approximately parallelepipedal housing 102. In addition, three pushbutton keys, a closing key 104, an opening key 106 and a supplementary key 108, are provided on a broad side of the housing 102.

All three pushbutton keys are connected to a control device 34 and have the purpose of opening or closing an access point or of carrying out a supplementary function (for example opening the lid of a luggage space).

A rotary axis 110, which extends perpendicularly with respect to the broad sides of the housing 102, is formed at one corner of the housing 102. A mechanical key 112 is rotatably mounted on the rotary axis 110. In the rest position shown by unbroken lines, the key 112 is folded in and lies in a suitable receptacle parallel to a narrow side of the housing 102. In the folded-out state, the key protrudes perpendicularly with respect to the housing 102, as is shown by dashed lines at 112′. In this position, the identification signal transmitter 100 can be used as a normal key, for example for an ignition lock of a motor vehicle.

Finally, the housing 102 also has two charging contacts 114 for a rechargeable accumulator which is arranged in the interior of the housing 102. As an alternative to separate charging contacts 114 it is also possible to use the key 112 as a charging contact.

1. A portable modular wirefree identification signal transmitter for actuating, in particular for opening and/or closing, access points such as doors, gates, etc., remotely, having
a housing which has at least one externally accessible receptacle for accommodating a respective exchangeable system module, an identification code of a wirefree access control system being stored in the system module,
a control device which is permanently arranged in the housing and is configured to read the identification code of a system module which is being accommodated, and
at least one transmitter device which is permanently arranged in the housing and, in conjunction with the control device, has the purpose of transmitting the identification code of a system module which is being accommodated to a reader device of the access control system, which reader device is assigned to an access point,
wherein the identification signal transmitter can be used for opening and closing access points with different wirefree access control technologies.

2. The identification signal transmitter according to claim 1, having a receiver device for receiving signals from the reader device.

3. The identification signal transmitter according to claim 1, wherein an antenna is permanently arranged in the housing and forms the transmitter device and/or the receiver device.

4. The identification signal transmitter according to claim 1, wherein the housing has a plurality of receptacles for accommodating a different system module in each case.

5. The identification signal transmitter according to claim 1, wherein at least one system module has an integrated control and transmitter device and does not have any connection to the central control device or transmitter device.

6. The identification signal transmitter according to claim 1, wherein an identification code for an access control system is stored in a system module which is permanently arranged in the housing.

7. The identification signal transmitter according to claim 1, wherein the housing has a receptacle for an energy store.

8. The identification signal transmitter according to claim 1, wherein an interface for charging a rechargeable accumulator which is inserted into the receptacle is provided on the housing.

9. The identification signal transmitter according to claim 8, wherein at least one electrical contact which can be accessed from the outside is provided on the housing as a charging interface.

10. The identification signal transmitter according to claim 1, wherein an interface for connecting to a programming medium is provided on the housing.

11. The identification signal transmitter according to claim 1, wherein the control device has program-controlled locking means by means of which individual system modules can be locked so that their stored identification code is not transmitted.

12. The identification signal transmitter according to claim 1, wherein the housing has a receptacle for an enabling module, and wherein at least one system module is locked so that its stored identification code is not transmitted if the enabling module is not accommodated.

13. The identification signal transmitter according to claim 1, wherein at least one activation element which is connected to the control device is provided on the outside of the housing, wherein the control device reads the identification code of at least one system module when the activation element is activated, and said control device actuates the transmitter device in order to transmit the identification code.

14. The identification signal transmitter according to claim 1, having a receiver device for receiving signals from the reader device, wherein the control device interrogates periodically whether the receiver device has received an activation signal, and when an activation signal is received it reads the identification code of at least one system module and actuates the transmitter device in order to transmit the identification code.

15. The identification signal transmitter according to claim 1, wherein at least one mechanical key is mounted on the housing so as to be moveable between a protruding locking position and a position of rest which is adjacent the housing.

16. A wirefree access control system for at least one access point such as a door or a gate, wherein the access control system has a lock for the access point and a reader device which is assigned to the access point, and when a valid identification code is received, it actuates the lock in order to open the access point, and wherein the access control system has at least one portable modular identification signal transmitter for actuating, in particular for opening and/or closing, the access point remotely, having
a housing which has at least one externally accessible receptacle for accommodating a respective exchangeable system module, an identification code of a wirefree access control system being stored in the system module,
a control device which is permanently arranged in the housing and is configured to read the identification code of a system module which is being accommodated, and
at least one transmitter device which is permanently arranged in the housing and, in conjunction with the control device, has the purpose of transmitting the identification code of a system module which is being accommodated to a reader device of the access control system, which reader device, is assigned to an access point,
wherein the identification signal transmitter can be used for opening and closing access points with different wirefree access control technologies.
